(19) United States
(12) Patent Application Publication
(10) Pub. No.: US 2006/0182482 A1
(43) Pub. Date: Aug. 17, 2006

(54) Printing apparatus and method of transporting record medium in printing apparatus

(75) Inventors: Yasutaka Shibagaki, Nagano (JP); Hiroshi Katayama, Nagano (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/347,598

(22) Filed: Feb. 3, 2006

(30) Foreign Application Priority Data
Feb. 3, 2005 (JP) P2005-027624

(51) Int. Cl. B41J 19/00

(52) U.S. Cl. 400/319

(57) ABSTRACT

A printing apparatus including a carriage driver for driving a carriage and a transport driver for transporting a record medium, wherein record on the record medium is carried out by means of a recording head provided in the carriage, is characterized by having a controller for driving the carriage driver before the transport driver completes transport of the record medium for supplying the printing position with the record medium.

### BACKGROUND OF THE INVENTION

1. Technical Field of the Invention

The invention relates to a printing apparatus and a method of transporting a record medium in a printing apparatus, particularly, a printing apparatus and a method of transporting a record medium in a printing apparatus in which a moving operation of a carriage is performed during an operation of feeding printing paper.

2. Description of the Related Art

In a related art, a superposition process for superposing a paper transport operation on a carriage operation in order to improve a process time in printing has been carried out in a printing apparatus such as a printer. In the superposition process, a paper-feeding motor (a PF motor) is activated to perform transport of paper after completing a printing process for one pass. A carriage motor (a CR motor) is then activated in predetermined timing before a drive of the PF motor is completed so as to move a carriage. This allows the printing process to be performed simultaneously with completion of the paper transport operation. Accordingly, the process time in printing can be improved more than the case that the CR motor is activated after completing the paper transport operation so as to move the carriage.

For such a superposition process, there has been a method proposed in which a start delay of a carriage due to a complicated calculating process is prevented by calculating timing for starting the carriage on the basis of a subtraction value between an estimation time from a start of a drive of the carriage to a start of printing and a set time stored in a memory (JP-A-2004-90431, FIG. 5, etc. mentioned below, for example).

Such a superposition process, however, has been carried out after 5 completing the printing process for one pass and has not been performed in feeding printing paper. This is because superposition of the paper transport operation for feeding paper on the carriage operation sometimes causes printing out of paper. This is caused when the paper actuary fed is shorter than the length of the paper designated by a printer driver, for 1 o example.

On the other hand, as for the paper transport operation for feeding paper, the related art printing apparatus is provided with a paper detection sensor for detecting a change from “no paper” to “with paper” for the purpose of detecting an error in feeding. Detection of the change from “no paper” to “with paper” is only required while detection of a change from “with paper” to “no paper” is not necessarily needed, since the paper transport operation in feeding paper includes an operation of transporting paper.

### SUMMARY OF THE INVENTION

In view of the above, an object of the invention is to provide a printing apparatus and a method of transporting a record medium in a printing apparatus in which a processing time of a whole printing process from feeding to printing is made shorter.

Another object of the invention is to provide a printing apparatus and such for preventing printing from being performed out of a record medium.

At least one of the above objects is achieved by the following invention:

(1). A printing apparatus comprising:

a recording head, adapted to perform a printing onto a medium at a record starting position;

a carriage, provided with the recording head thereon;

a carriage driver, adapted to drive the carriage;

a transport driver, adapted to transport the medium to the record starting position; and

a controller, operable to control the carriage driver and the transport driver, wherein

the controller controls the carriage driver to start a driving of the carriage toward the record starting position before the transport driver completes a transportation for feeding the medium to the record starting position.

This allows the printing process to be started by means of the recording head immediately after the feeding operation is completed, for example, so that the processing time of a whole printing process can be shortened.

(2). The printing apparatus according to (1), further comprising a sensor adapted to detect a change from a state with the medium to a state without the medium during the transportation, wherein

the controller controls the carriage driver to drive the carriage toward the record starting position when the sensor does not detect the change.

Accordingly, the carriage driver is arranged to be driven when the detecting sensor detects no change from the condition with the record medium to the condition without the record medium, for example. This can prevent printing from being performed out of the record medium.

(3). The printing apparatus according to (2), wherein when the sensor detects the change, the controller controls the carriage driver in accordance with whether a printing region is existed or not.

(4). The printing apparatus according to (3), wherein when the printing region is existed, the controller controls the carriage driver to drive the carriage toward the record starting position.

(5). The printing apparatus according to (3), wherein when the printing region is not existed, the controller controls the transport driver to eject the medium outside the printing apparatus without printing.

This allows printing to be prevented from being performed out of the record medium since the record medium is ejected when the detecting sensor detects a change from the condition with the record medium to the condition without the record medium, for example.

(6). The printing apparatus according to (2), wherein the controller controls the transport driver to perform a positioning of the medium in a transporting path during the transportation.

This allows the record medium to be skew-corrected, for example, so that printing can be carried out at a desired point on the record medium.

(7). The printing apparatus according to (2), wherein the controller calculates during the transportation a starting time when the carriage starts the driving and controls the carriage driver to start the driving before the transport driver completes the transportation.

(8). The printing apparatus according to (7), further comprising a comparing processor adapted to compare a first period from a predetermined time after starting the transportation by the controller to a completing time of the transportation with a second period from a starting time of the driving of the carriage by the controller until a starting time of the printing, wherein

the controller changes the starting time of the driving in accordance with a result obtained by the comparing processor.

(9). The printing apparatus according to (8), wherein when the first period is larger than the second period, the controller controls the carriage driver to drive the carriage so that the printing is started at the completing time of the transportation.

(10). The printing apparatus according to (8), wherein when the second period is larger than the first period, the controller controls the carriage driver to start the driving of the carriage at the predetermined time.

(11). A transporting method performed in a printing apparatus comprising:

a recording head, adapted to perform a printing onto a medium at a record starting position;

a carriage, provided with the recording head thereon;

a carriage driver, adapted to drive the carriage; and

a transport driver, adapted to transport the medium to the record starting position, the method comprising:

transporting the medium for feeding the medium to the record starting position, and

controlling the carriage driver to start a driving of the carriage toward the record starting position before completing the transporting.

Accordingly, the printing process is carried out by means of the recording head immediately after the feeding operation is completed, for example. This allows the processing time of a whole printing process to be shortened.

(12). The transporting method according to (11), further comprising detecting a change from a state with the medium to a state without the medium during the transporting.

(13). The transporting method according to (12), further comprising detecting whether a printing region is existed or not when detecting the change.

(14). The transporting method according to (13), wherein the controlling the carriage driver is executed and the printing is executed when the printing region is existed.

(15). The transporting method according to (13), wherein the controlling the carriage driver is not executed and the medium is ejected outside the printing apparatus when the printing region is not existed.

(16). The transporting method according to (12), further comprising calculating during the transporting a starting time when the carriage starts the driving.

(17). The transporting method according to (16), further comprising:

comparing a first period from a predetermined time after starting the transporting to a completing time of the transporting with a second period from a starting time of the driving until a starting time of the printing; and

changing the starting time of the driving in accordance with a result obtained by the comparing.

(18). The transporting method according to (17), wherein when the first period is larger than the second period, the controlling is executed so that the printing is started at the completing time of the transporting.

(19). The printing apparatus according to (17), wherein when the second period is larger than the first period, the controlling is executed to start the driving of the carriage at the predetermined time.

### BRIEF DESCRIPTION OF THE DRAWINGS

FIG. 1 shows an inner structure of an embodiment of a printing apparatus to which the invention is applied.

FIG. 2 is a sectional view of an inner structure of the printing apparatus.

FIG. 3 illustrates an electrically structure of the printing apparatus.

FIG. 4 illustrates driving waveforms of a CR motor and a PF motor.

FIG. 5A illustrates a difference in printing position in accordance with arrangement of image data while FIG. 5B illustrates a reference point of a in printing paper.

FIGS. 6A and 6B illustrate timings for starting a drive of a CR motor (A≧T).

FIGS. 7A and 7B illustrate timings for starting a drive of a CR motor (A<T).

FIG. 8A shows an example of printing data and FIG. 8B shows an example of a printing position on printing paper.

FIG. 9 illustrates timing for starting a drive of a CR motor (A<T).

FIG. 10 illustrates timing for starting a drive of a CR motor (A<T).

FIG. 11A shows an example of a printing position on printing paper while FIG. 11B illustrates an example of an operation of skew correction.

FIG. 12A is a flowchart of a whole feeding process while FIG. 12B is a flowchart of a process carried out during a paper-transporting operation.

FIG. 13A illustrates driving waveforms of respective motors in the case that no superposition process is carried out during a feeding operation while FIG. 13B illustrates the driving waveforms in the case that a superposition process is carried out during a feeding operation.

### DETAILED DESCRIPTION OF THE INVENTION

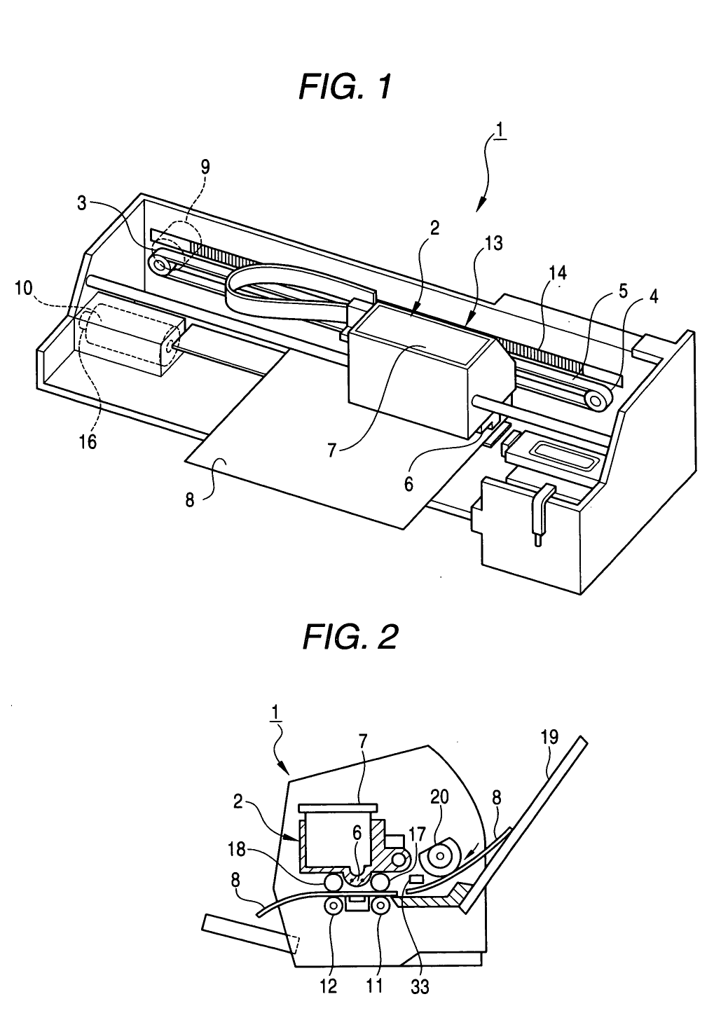

An embodiment for carrying out the invention will be described hereinafter with reference to the drawings. FIG. 1 shows an example of a printing apparatus 1 to which the invention is applied.

As shown in FIG. 1, the printing apparatus 1 includes a carriage 2. The carriage 2 comprises a detachably provided ink cartridge 7 and a recording head 6 supplied with ink from the ink cartridge 7. The recording head 6 includes plural nozzles from which ink is ejected on printing paper 8, which is an example of a record medium, to perform printing.

The printing apparatus 1 also includes a driving pulley 3, a driven pulley 4, a timing belt 5 tensed around the pulleys 3 and 4 and a carriage motor (a CR motor) 9 used as a carriage driver. The carriage 2 is mounted to the timing belt 5. Rotation of the CR motor 9 rotates the driving pulley 3 to move the timing belt 5. The carriage 2 is moved in a main scanning direction with the movement of the timing belt 5.

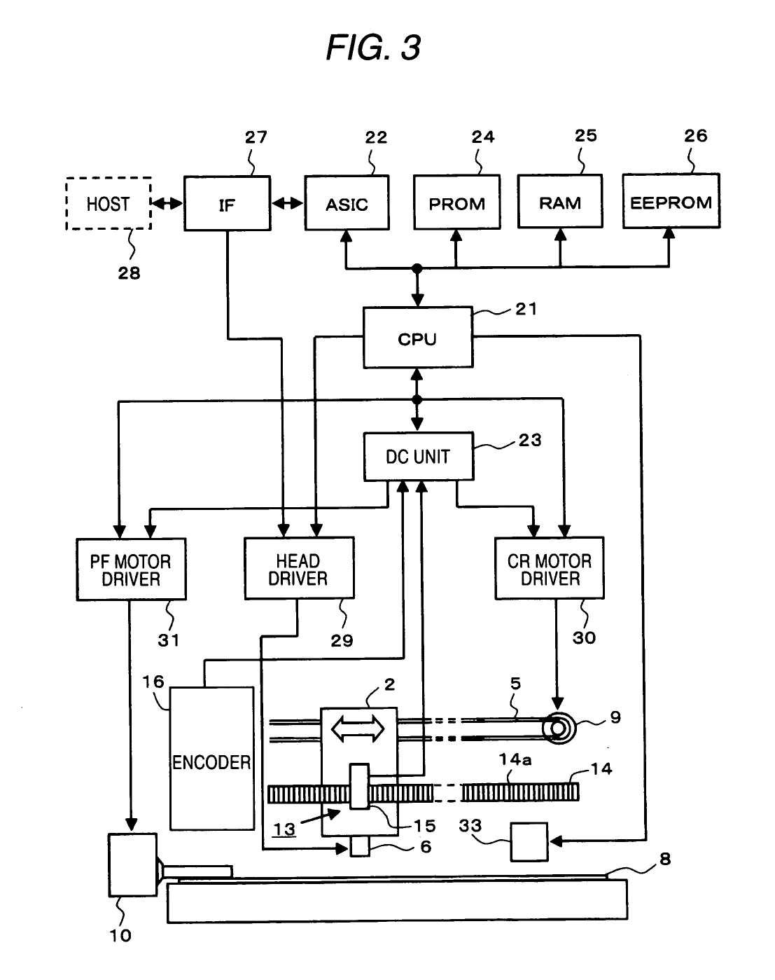

Moreover, the printing apparatus 1 is provided with a linear encoder 13 for detecting a moving velocity, a moving direction, a location and the like of the carriage 2. The linear encoder 13 comprises a tape to be detected 14, which is provided on a side wall of an inner surface of the printing apparatus 1, and a carriage detecting sensor 15 (refer to FIG. 3) fixed on a back surface of the carriage 2. The tape to be detected 14 is formed with innumerable slits 14a with a predetermined space therebetween (refer to FIG. 3). Detection of the slits 14a by means of the carriage detecting sensor 15 enables the linear encoder 13 to detect the moving velocity, the location and the like of the carriage 2.

The printing apparatus 1 is also provided on its lower side end with a paper-feeding motor (a PF motor) 10 used as a transport driver and a rotary encoder 16. The PF motor 10 rotates respective rollers to supply the printing paper 8 into the printing apparatus 1 so as to transport the paper in a sub scanning direction. The rotary encoder 16 is for detecting a transporting velocity, a moving direction, a location and the like of the printing paper 8. The rotary encoder 16 is almost same as the linear encoder 13 other than the tape to be detected, which is provided in a rotary disk.

FIG. 2 is a sectional view of the printing apparatus 1 and mainly illustrates a structure of a transport system of the printing paper 8. The printing apparatus 1 includes a paper-feeding tray 19 and, in the order from the upper stream side, a feeding roller 20, a transport roller 11, a driven roller 17 of the transport roller 11, a eject roller 12 and a driven roller 18 of the eject roller 12. The respective rollers 20, 11 and 12 are connected to the PF motor 10.

The printing paper 8 placed on the paper-feeding tray 19 is supplied into the printing apparatus 1 by rotation of the feeding roller 20 with a drive of the PF motor 10. The drive of the PF motor 10 then causes rotation of the transport roller 11 to transport the printing paper 8 to a printing position so as to perform printing by means of the recording head 6. After the above, the PF motor 10 is driven to rotate the eject roller 12, and thereby, the printing paper 8 is ejected. The transport roller 11 having a resist function carries out skew correction for the purpose of accurate positioning with respect to the printing paper 8.

Further, the printing apparatus 1 is provided with a paper detecting sensor 33, which is a characteristic part of the invention, as a record medium detecting sensor, as shown in FIG. 2. The paper detecting sensor 33 detects a change of a condition from “without paper” to “with paper” for the purpose of detecting an error in feeding the printing paper 8 into the printing apparatus 1 and a change of a condition from “with paper” to “without paper” for the purpose of preventing printing from being performed out of the printing paper 8 after completing the feed of paper. The detail will be described later.

FIG. 3 illustrates a whole electrical structure of the printing apparatus 1. The printing apparatus 1 comprises a CPU 21, an ASIC 22, a DC unit 23, a PROM 24, a RAM 25, an EEPROM 26, an interface (IF) 27 and respective drivers 29, 30 and 31. The printing apparatus 1 is connected to a host computer 28.

Printing data supplied from the host computer 28 is inputted to the ASIC 22 through the IF 27. The CPU 21 sets a printing schedule of the recording head 6 on the basis of the printing data. The CPU 21 controls a drive of the recording head 6 through a head driver 29 on the basis of the printing schedule.

The CPU 21 also sets activation and a running schedule of the CR motor 9 and the PF motor 10 on the basis of the printing data. The set running schedule and the like is outputted as a command signal from the CPU 21 to the DC unit 23.

The DC unit 23 controls a drive of the CR motor 9 through the CR motor driver 30 and a drive of the PF motor 10 through the PF motor driver 31 on the basis of the command signal. A pulse signal detected by means of the carriage detecting sensor 15 of the linear encoder 13 is inputted to the DC unit 23 in driving the carriage 2 so as to calculate a moving velocity and such of the carriage 2. A pulse signal from the rotary encoder 16 is also inputted to the DC unit 23 in transporting the printing paper 8 so as to calculate the driving velocity of the PF motor 10, the transporting velocity of the printing paper 8 and the like. The DC unit 23 controls the respective motors 9 and 10 to reach a predetermined rotational speed and the like on the basis of the calculated values.

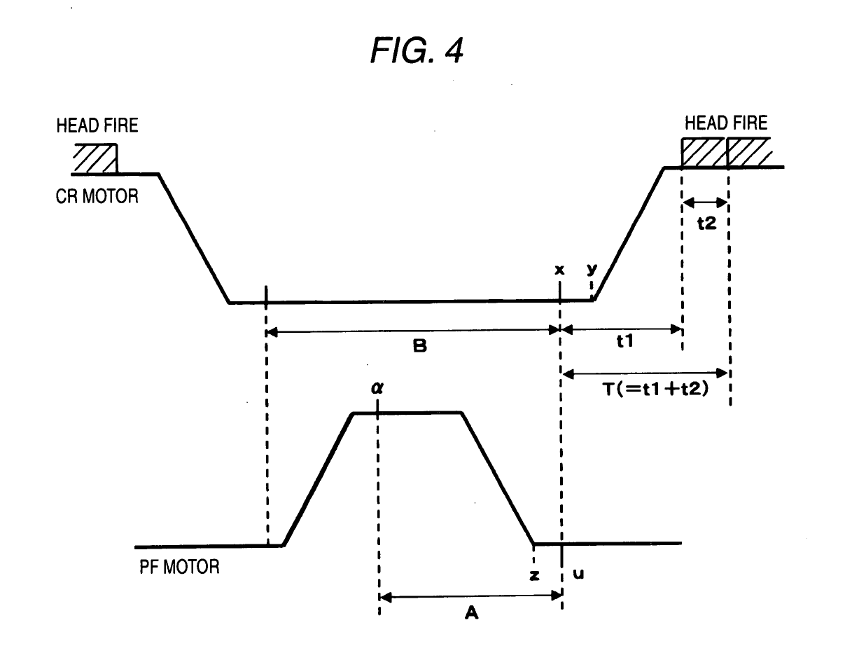

Now, the superposition process will be described in detail with respect to FIGS. 4 to 11. The superposition process is a process for superposing a moving operation of the carriage 2 on a paper-transporting operation of the printing paper 8 so as to actually start printing at a time of completing feed of the paper. That is to say, the superposition process is a process for starting a drive of the CR motor 9 before completing a drive of the PF motor 10.

Most simply, the CR motor 9 starts to be energized at the time when the PF motor 10 stops to complete feeding of paper so that the CR motor 9 can be driven. A time from a start of energizing the CR motor 9 to arrival of the carriage 2 at a printing position, however, is a waiting time. This causes much time to be taken for the printing process. Therefore, the CR motor 9 starts to be energized in predetermined timing before the PF motor 10 is driven to complete the feeding operation, and then, a superposition process for superposing the feeding operation on the operation of the carriage 2 is carried out. This allows the waiting time to be shortened, so that the processing time in printing can be shortened.

FIG. 4 illustrates waveforms showing driving velocity of the CR motor 9 and the PF motor 10. The horizontal axis denotes time while the vertical axis denotes the driving velocity. Time T from a start of energizing the CR motor 9 to arrival at the printing position will be first described.

As show in FIG. 4, the CR motor starts to be energized by means of the DC unit 23 at a certain time point x. Actually, the drive is started at a time point y in control since the CR motor 9 uses a DC motor in the embodiment. After a predetermined time t1 passes from the start of energization, ink is ejected from the recording head 6 to carry out printing. The passing time t1 is a time predetermined in accordance with a specification of a structure of the printing apparatus 1.

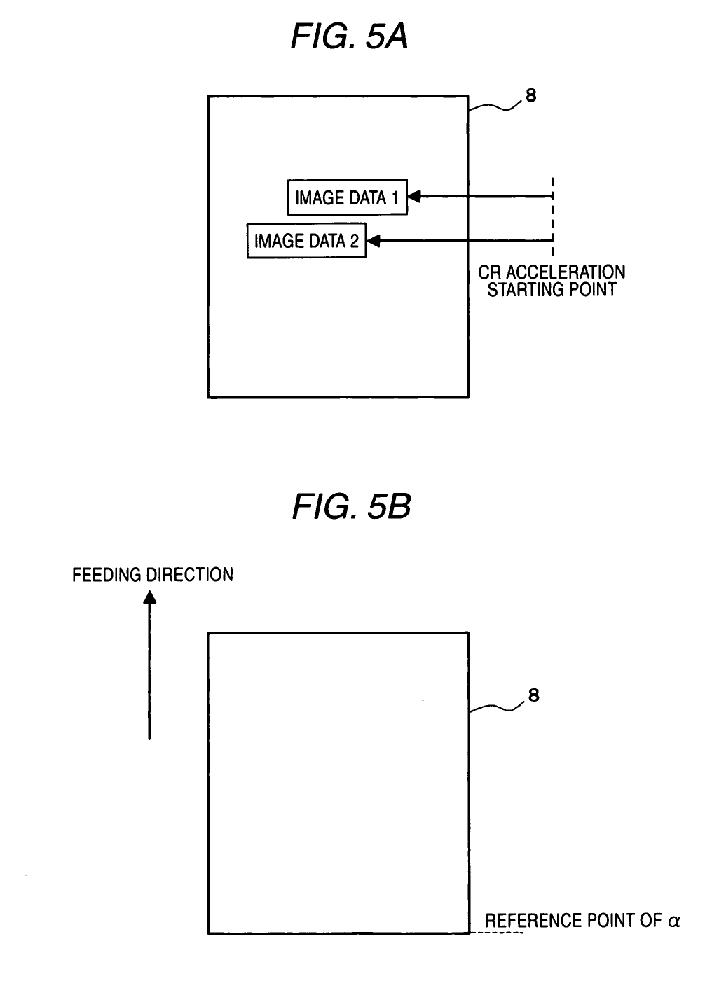

On the other hand, the printing position is different according to arrangement of image data (printing data). FIG. 5A illustrates a difference in printing position. As show in FIG. 5A, the printing position is different according to the location of the corresponding image data even in the case that the carriage 2 starts acceleration from the same point.

Accordingly, the time from a start of energizing the CR motor 9 to arrival at the printing position is, in practice, a value T obtained by adding a passing time t2 to the predetermined time t1, as show in FIG. 4. t1 is fixed while t2 is different in accordance with the location of image data.

Next, a driving time B of the PF motor 10 will be described. The PF motor 10 also has a margin of a predetermined time such as a time from a start of a drive to an actual drive. Accordingly, the driving time B appears as shown in FIG. 4.

In FIG. 4, time α is time capable of earliest activation of the CR motor 9. Activating the CR motor 9 at the time a allows printing to be carried out by means of the recording head 6 after activation of the PF motor 10. α denotes time calculated on the basis of a distance from the paper detecting sensor 33 to the recording head 6. In the case of feeding the printing paper 8 as shown in FIG. 5B, namely, when the printing paper 8 is fed from the upper part in FIG. 5B, the lowest part of the printing paper 8 is a reference point of α.

A time A is a time from α to a point of time when the PF motor 10 stops activation (refer to FIG. 4). The time A varies in accordance with a speed of feeding the printing paper 8.

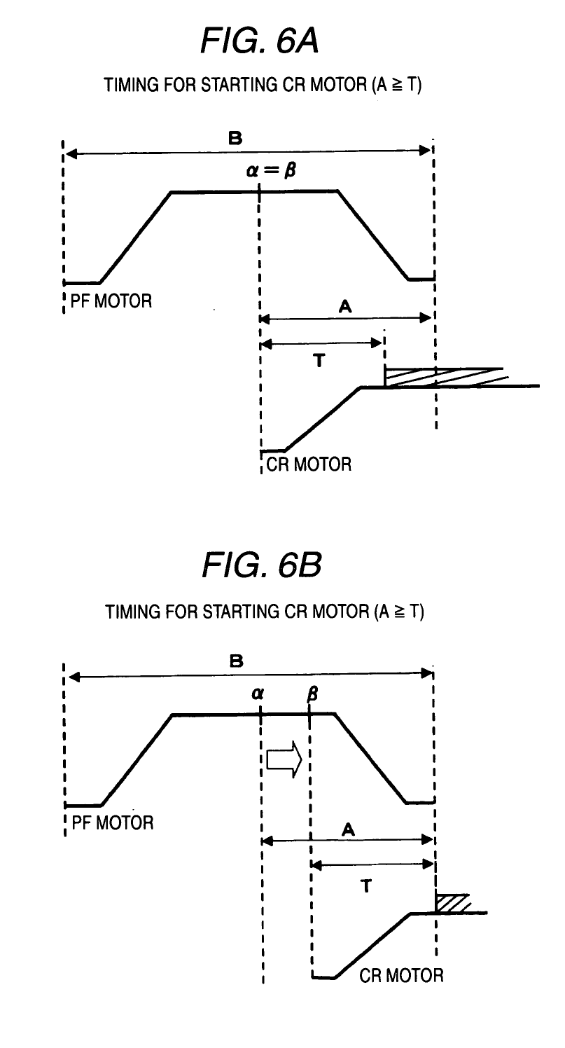

FIG. 6 illustrates timing for starting activation of the CR motor 9. In FIG. 6,β denotes time for starting activation of the CR motor 9. In the superposition process, a problem is in which timing activation of the CR motor 9 should be started during activation of the PF motor 10.

As described above, the time α is the time capable of earliest activation of the CR motor 9. Accordingly, activation of the CR motor 9 can be started at timing of the time α. In the case that the time A is same as or longer than the time T in comparison, however, starting activation of the CR motor 9 in the timing of α causes printing to be started during activation of the PF motor 10 as shown in FIG. 6A. In this case, a record image is first printed in an oblique direction, and then, in the main scanning direction (or first in the main scanning direction, and then, in an oblique direction) on the printing paper 8, for example, since printing is performed during the paper-transporting operation. Therefore, the time β for starting activation of the CR motor 9 is delayed a little to be set at a point of time when the time T has passed in counting backward from a point of time when a drive of the PF motor 10 is completed in the case that the time A is same as or longer than the time T (refer to FIG. 6B). That is to say, the starting time β is a point of time when a time of (B-T) has passed when the print starting point is accorded with the time of completion of activation of the PF motor 10. Thus, printing is started at the same time as completion of feeding of paper, so that the time for the printing process can be shortened.

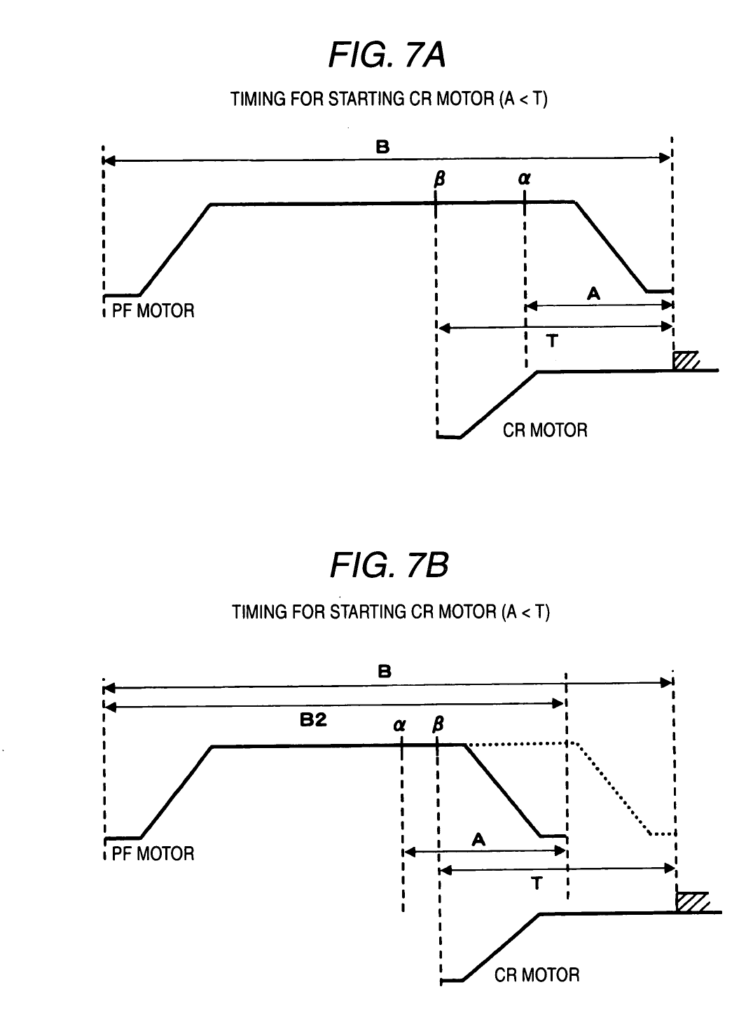

On the other hand, in order to perform printing simultaneously with completion of a drive of the PF motor 10 similarly to the above case when the time T from a start of a drive of the CR motor 9 to printing is longer than the time A from the time a to completion of a drive of the PF motor 10, the time β for starting activation of the CR motor 9 can be set as shown in FIG. 7A. The CR motor 9 is activated earlier than the case in FIG. 6B.

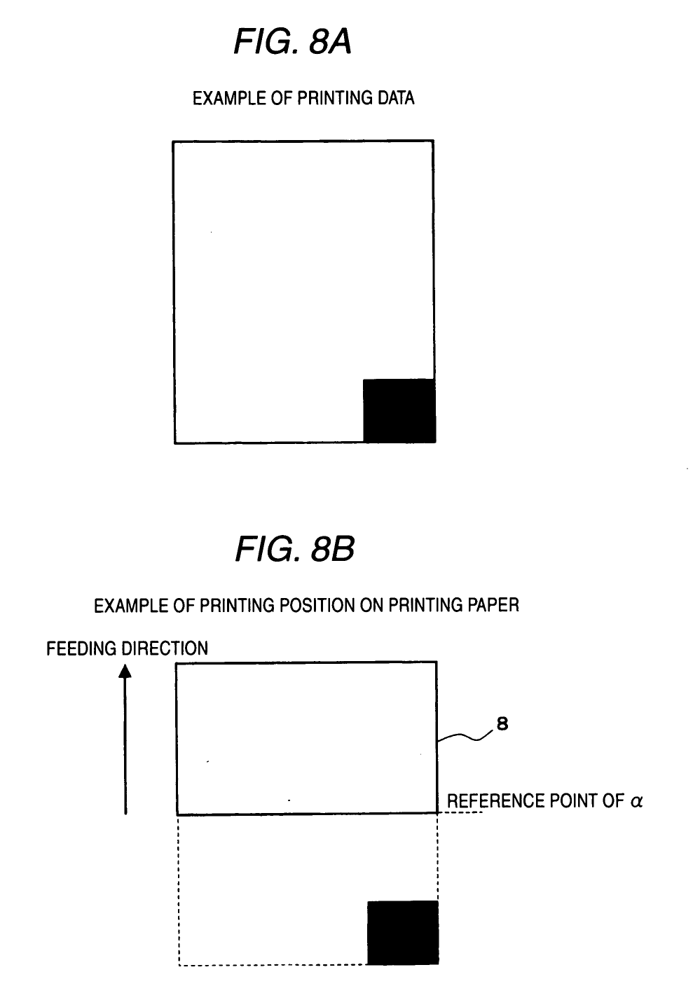

In the case that the length of the actually fed printing paper 8 in the feeding direction is shorter than the designated length, however, the driving time B of the PF motor 10 is shortened into B2 so as to correspond to the shortened length of the paper 8 in the feeding direction. This causes printing to be performed out of the paper 8. FIG. 8 illustrates such a condition. For example, a printing area (an area show by a black square part) is out of the printing paper 8 when the length of the actually fed printing paper 8 in the feeding direction is short as shown in FIG. 8B even in the case that the host computer 28 designates printing data as shown in FIG. 8A. This causes printing out of the paper 8.

That is to say, when the actually fed paper 8 is shorter than the designated length, the CR motor 9 has already started driving at a point of time of detection of a condition without the paper 8 to carry out printing at a point where no paper 8 exists, and therefore, printing is performed out of the paper 8 even in the case of setting the starting time β of the CR motor 9 for the purpose of shortening the time for the printing process. A time from a stop point of the PF motor 10 does not vary even when the length of the printing paper 8 in the paper-transporting direction is changed as shown in FIGS. 7A and 7B since a reference point of the time a is the lowest end of the printing paper 8 as described above. In the case that the length of the printing paper 8 becomes shorter, for example, the time from completion of a drive of the PF motor 10 does not change since the reference point of the time a is the lowest end of the paper 8 as shown in FIG. 8B.

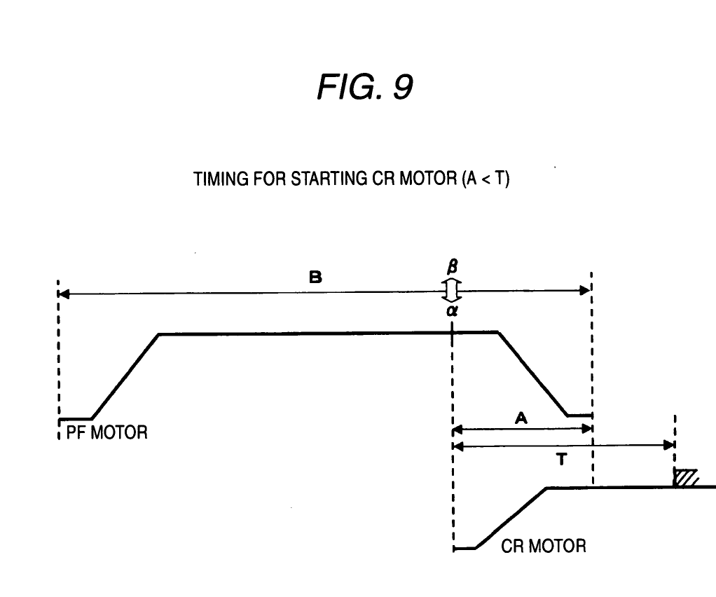

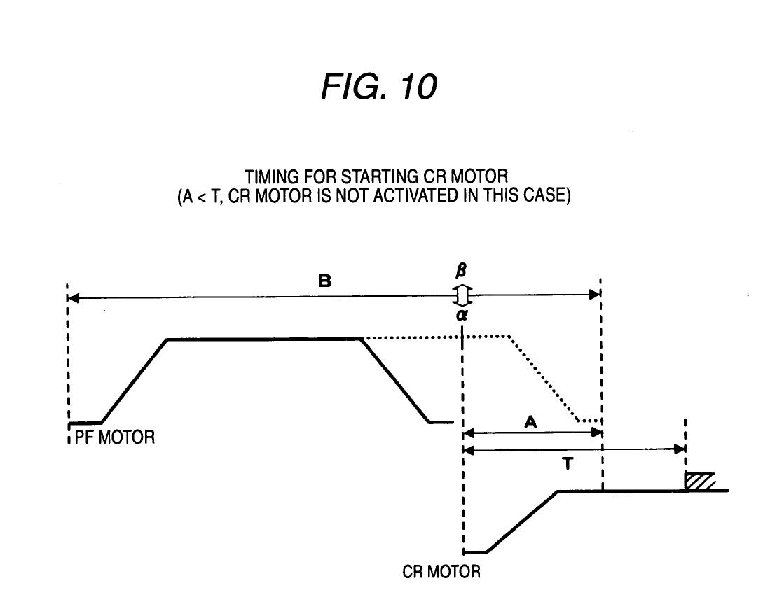

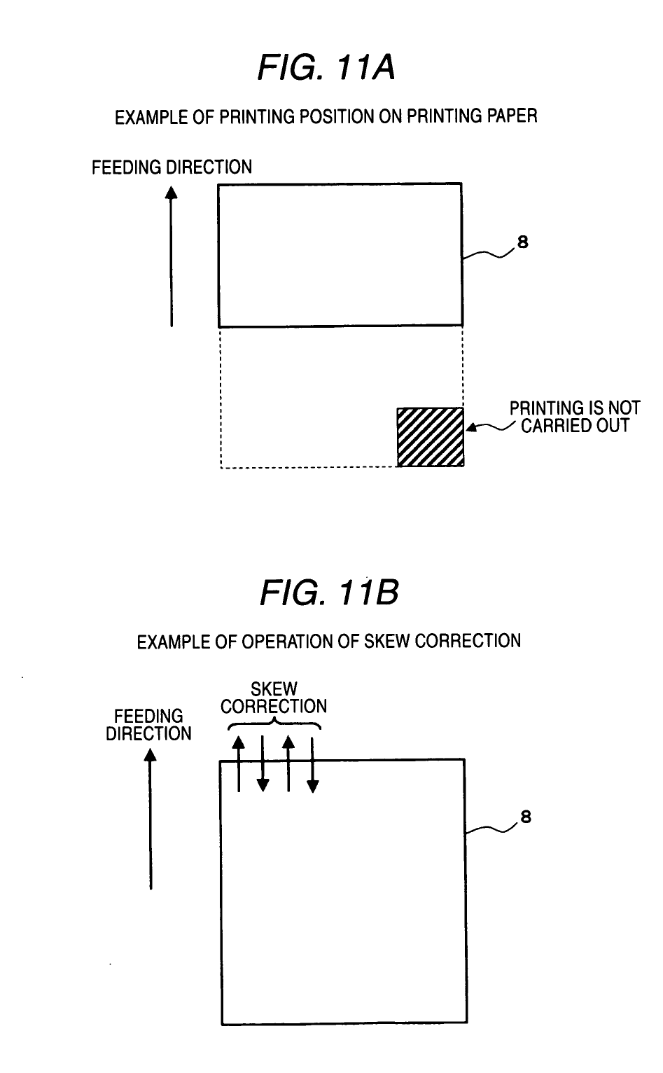

In order to prevent such printing out of the paper 8 from occurring, the starting time β of the CR motor 9 is delayed a little more than the case in FIG. 7A to be set at the time a (refer to FIG. 9). Such setting allows the time β to appear after completion of a drive of the PF motor 10 in the case that the length of the paper 8 in the feeding direction becomes shorter (refer to FIG. 10), a drive of the CR motor 9 is not started, and thus, printing out of the paper 8 can be prevented (refer to FIG. 11A). In the printing apparatus 1 in the embodiment, the CR motor 9 is arranged not to be driven after completion of a drive of the PF motor 10.

In accordance with the above, the timing for starting a drive (starting of energization) of the CR motor 9 in the superposing process is when the time (B-T) has passed in the case that the passing time A is same as or longer than the passing time T while the timing is the time α in the case that the time A is shorter than the time T.

The superposition process has been conventionally carried out when printing for one pass is completed. In the invention, however, the superposition process is also performed during the feeding operation. That is to say, the superposition process is arranged to be also carried out in the operation of transporting paper by feeding in the invention. For the purpose of preventing printing from being performed out of the printing paper 8 in the case that the length of the printing paper 8 in the paper-transporting direction is shorter as described above, for example, monitored is a change from a condition of “with paper” to a condition of “without paper” by means of the paper detecting sensor 33. The feeding in the embodiment means transport of paper to a print starting point. It is different from transport of paper after completion of printing for one pass or transport for discharging paper.

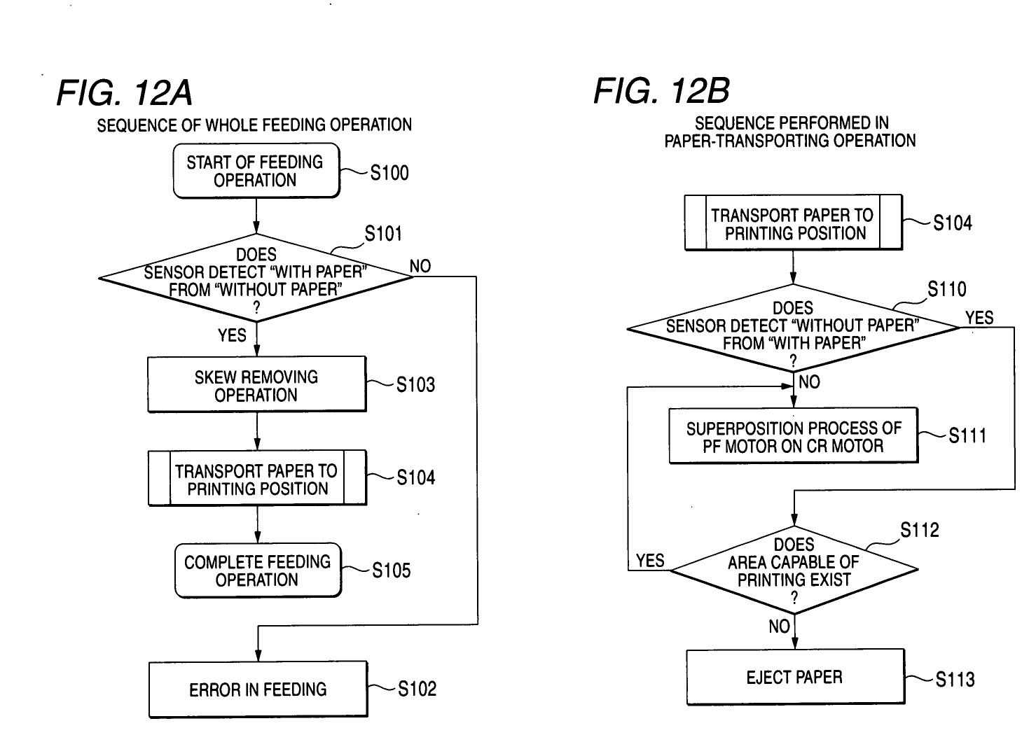

The superposition process performed in the feeding operation will be described in detail. FIG. 12A is a flowchart showing a whole process of the feeding operation.

First, the PF motor 10 rotates the feeding roller 20 to start the operation of feeding the printing paper 8 (S100). Then, the CPU 21 judges whether the paper detecting sensor 33 detects a change from “without paper” to “with paper” or not (S101). This is for preventing an error in feeding by detecting the printing paper 8. Accordingly, a condition is judged to be a feeding error (S102) when “with paper” is not detected (NO).

On the other hand, a skew removing operation is carried out (S103) when the change form “without paper” to “with paper” is detected (in the case of YES in S101). This is for accurately positioning the fed printing paper 8 in its transporting path. The transport roller 11 is used for pressuring the printing paper 8 and reciprocating the same in plural number of times so as to carry out the operation (refer to FIG. 11B). For example, controlling the PF motor 10 by means of the DC unit 23 enables the operation to be performed.

Next, the printing paper 8 is transportred to the printing position (S104). This is for actually carrying out printing at the printing position. For example, the DC unit 23 controls the PF motor 10, and thereby, the feeding roller 20 and the transport roller 11 are driven for rotation so as to carry out transport of the paper to the printing position.

During the paper-transporting operation, the process shown in FIG. 12B is performed. That is to say, the CPU 21 judges whether the paper detecting sensor 33 detects a change from “with paper” to “without paper” or not (S110). The printing paper 8 has been fed since the detecting sensor 33 has already detected the change from “without paper” to “with paper” (YES in S101). When the length of the printing paper 8 in the paper-transporting direction is shorter than the designated length, however, printing is sometimes performed out of the paper 8 as described above. In order to prevent such a condition from occurring, the paper detecting sensor 33 is used for detecting (monitoring) a change from “with paper” to “without paper”.

In the case that the change from “with paper” to “without paper” is not detected by means of the detecting sensor 33 (NO in S110), the above-mentioned superposition process of the PF motor 10 on the CR motor 9 is carried out for the purpose of performing printing on the printing paper 8 for the first pass (S111). In accordance with the superposition process in the feeding operation, the PF motor 10 shown in FIG. 6, for example, is used for a motor drive for the purpose of feeding paper while the CR motor 9 is used for driving the carriage 2 for the purpose of printing for the first pass.

On the other hand, in the case that the change from “with paper” to “without paper” is detected by means of the detecting sensor 33 (YES in S110), namely, when the length of the printing paper 8 is shorter than the designated length, the CPU 21 judges whether the area capable of printing exists or not (S112). This is because printing is carried out when there is the area capable of printing even in the case that the length of the paper 8 is shorter than the designated length. When there is no area capable of printing (NO), the fed paper 8 is ejected (S113). When the area capable of printing exists (YES in S112), the superposition process is performed for the purpose of carrying out printing in the printing area (S111). In the case of printing letters “ABC”, for example, the superposition process is carried out for the purpose of printing the letters “AB” so long as there is an area capable of only printing “AB” even when the length of the printing paper 8 is shorter than the designated length. The feeding operation is completed after the above (S105 in FIG. 12A), and then, a series of processes is completed.

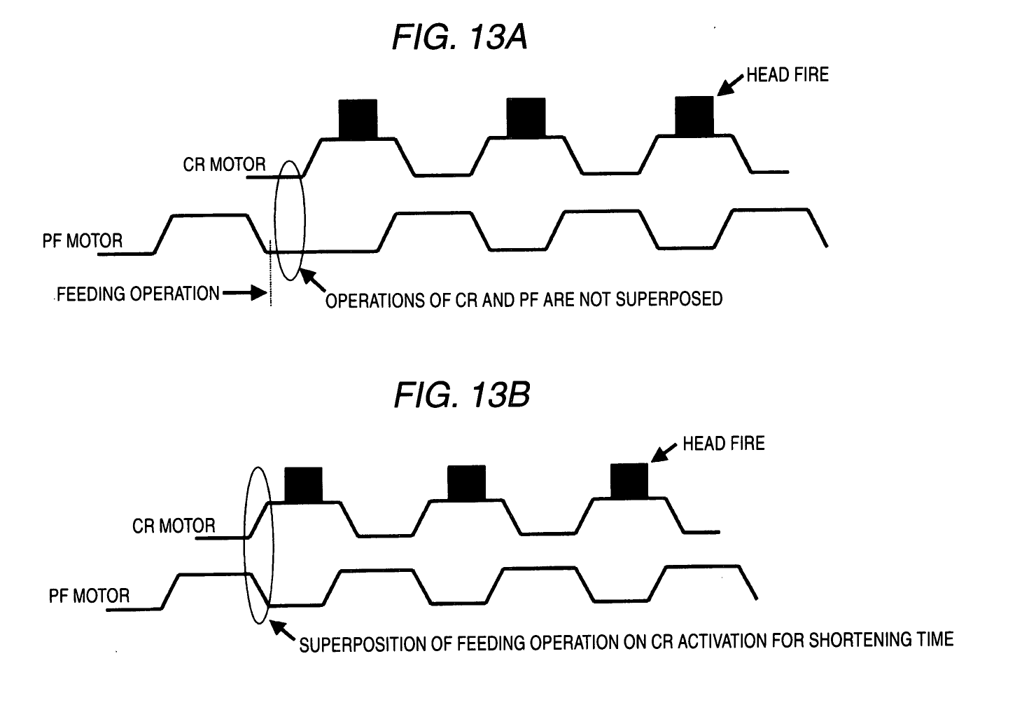

Performing the superposition process of the PF motor 10 on the CR motor 9 during the operation of transporting the printing paper 8 as described above allows a processing time of the whole printing process to be shortened. FIG. 13 illustrates an example of the above. In the case that no superposition process of the CR motor 9 on the PF motor 10 is carried out during the feeding operation (FIG. 13A), the CR motor 9 is driven in order to carry out printing for the first pass after completing a drive of the PF motor 10 for the purpose of feeding paper. On the other hand, in the case of performing the superposition process during the feeding operation (FIG. 13B), the drive of the CR motor 9 is superposed on the drive of the PF motor 10 for the feeding operation. Accordingly, the drive of the CR motor 9 is started earlier than the case of FIG. 13A, and further, the drive of the PF motor 10 is also started relatively earlier. This allows the time for the whole printing process to be shortened, so that the process can be performed at a higher speed.

In the above-mentioned embodiment, a so-called printer is used as the printing apparatus 1 for the purpose of description. The printing apparatus 1 may be a facsimile machine, a copying machine or a compound machine having those functions other then the above.

Further, the printing paper 8 exemplifies the record medium in the above-mentioned embodiment. The record medium may be whatever can record ink ejected from the recording head 6. Paper for an OHP, cardboard, a post card and the like may be used as the record medium.

Moreover, the CR motor 9 and the PF motor 10 are described as the DC motor in the above-mentioned embodiment. They may be various kinds of motors such as a stepper motor other than the above. In the case of using a stepper motor, however, the timing for starting a drive of the CR motor 9 in the superposition process should be operated without considering a margin of a rising part or the like of the waveform of the drive shown in FIG. 4. In any case, the operational effect similar to that of the above-mentioned embodiment can be achieved in the invention.

What is claimed is:

1. A printing apparatus comprising:
a recording head, adapted to perform a printing onto a medium at a record starting position;
a carriage, provided with the recording head thereon;
a carriage driver, adapted to drive the carriage;
a transport driver, adapted to transport the medium to the record starting position; and
a controller, operable to control the carriage driver and the transport driver, wherein
the controller controls the carriage driver to start a driving of the carriage toward the record starting position before the transport driver completes a transportation for feeding the medium to the record starting position.

2. The printing apparatus according to claim 1, further comprising a sensor adapted to detect a change from a state with the medium to a state without the medium during the transportation, wherein
the controller controls the carriage driver to drive the carriage toward the record starting position when the sensor does not detect the change.

3. The printing apparatus according to claim 2, wherein when the sensor detects the change, the controller controls the carriage driver in accordance with whether a printing region is existed or not.

4. The printing apparatus according to claim 3, wherein when the printing region is existed, the controller controls the carriage driver to drive the carriage toward the record starting position.

5. The printing apparatus according to claim 3, wherein when the printing region is not existed, the controller controls the transport driver to eject the medium outside the printing apparatus without printing.

6. The printing apparatus according to claim 2, wherein the controller controls the transport driver to perform a positioning of the medium in a transporting path during the transportation.

7. The printing apparatus according to claim 2, wherein the controller calculates during the transportation a starting time when the carriage starts the driving and controls the carriage driver to start the driving before the transport driver completes the transportation.

8. The printing apparatus according to claim 7, further comprising a comparing processor adapted to compare a first period from a predetermined time after starting the transportation by the controller to a completing time of the transportation with a second period from a starting time of the driving of the carriage by the controller until a starting time of the printing, wherein
the controller changes the starting time of the driving in accordance with a result obtained by the comparing processor.

9. The printing apparatus according to claim 8, wherein when the first period is larger than the second period, the controller controls the carriage driver to drive the carriage so that the printing is started at the completing time of the transportation.

10. The printing apparatus according to claim 8, wherein when the second period is larger than the first period, the controller controls the carriage driver to start the driving of the carriage at the predetermined time.

11. A transporting method performed in a printing apparatus comprising:
a recording head, adapted to perform a printing onto a medium at a record starting position;
a carriage, provided with the recording head thereon;
a carriage driver, adapted to drive the carriage; and
a transport driver, adapted to transport the medium to the record starting position, the method comprising:
transporting the medium for feeding the medium to the record starting position, and
controlling the carriage driver to start a driving of the carriage toward the record starting position before completing the transporting.

12. The transporting method according to claim 11, further comprising detecting a change from a state with the medium to a state without the medium during the transporting.

13. The transporting method according to claim 12, further comprising detecting whether a printing region is existed or not when detecting the change.

14. The transporting method according to claim 13, wherein the controlling the carriage driver is executed and the printing is executed when the printing region is existed.

15. The transporting method according to claim 13, wherein the controlling the carriage driver is not executed and the medium is ejected outside the printing apparatus when the printing region is not existed.

16. The transporting method according to claim 12, further comprising calculating during the transporting a starting time when the carriage starts the driving.

17. The transporting method according to claim 16, further comprising:
comparing a first period from a predetermined time after starting the transporting to a completing time of the transporting with a second period from a starting time of the driving until a starting time of the printing; and
changing the starting time of the driving in accordance with a result obtained by the comparing.

18. The transporting method according to claim 17, wherein when the first period is larger than the second period, the controlling is executed so that the printing is started at the completing time of the transporting.

19. The printing apparatus according to claim 17, wherein when the second period is larger than the first period, the controlling is executed to start the driving of the carriage at the predetermined time.
